(19) United States
(12) Patent Application Publication
(10) Pub. No.: US 2026/0075199 A1
(43) Pub. Date: Mar. 12, 2026

(54) METHOD AND APPARATUS FOR VIDEO CODING THAT ADAPTIVELY USES SINGLE TREE AND DUAL TREE IN ONE BLOCK

(71) Applicants: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(72) Inventors: Je Won Kang, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(21) Appl. No.: 19/108,610

(22) PCT Filed: Aug. 7, 2023
(86) PCT No.: PCT/KR2023/011543

§ 371 Date: Mar. 4, 2025

(30) Foreign Application Priority Data
Sep. 15, 2022 (KR) 10-2022-0116562
Aug. 3, 2023 (KR) 10-2023-0101713

(51) Int. Cl. H04N 19/119; H04N 19/136; H04N 19/176

(52) U.S. Cl. CPC H04N 19/119; H04N 19/136; H04N 19/176

(57) ABSTRACT

A method and an apparatus are disclosed for video coding that adaptively use a single tree and a dual tree in a block. In particular, a video decoding device decodes information of the current block on a luma component and tree structure information of the current block. The video decoding device determines a tree structure of the current block to be a single tree or a dual tree based on the size of the current block, the current tree depth, and the tree structure information.

### CROSS-REFERENCE TO RELATED APPLICATIONS

This is a U.S. national stage of International Application No. PCT/KR2023/011543, filed on Aug. 7, 2023, which claims priority to Korean Patent Application No. 10-2022-0116562 filed on Sep. 15, 2022, and Korean Patent Application No. 10-2023-0101713, filed on Aug. 3, 2023, the entire contents of each of which are hereby incorporated herein by reference.

### TECHNICAL FIELD

The present disclosure relates to a video coding method and an apparatus that adaptively uses a single tree and a dual tree in a block.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

VVC techniques determine whether to use a single-tree structure or dual-tree structure for block partitioning based on the slice type of the video. However, with increasingly high-quality video nowadays, the need for a dual tree is increasing for chroma components regardless of the slice type. Therefore, there is a need to take into account adaptively using a single-tree structure and a dual-tree structure to increase the video encoding efficiency and especially to enhance the video quality of the chroma component.

### SUMMARY

The present disclosure seeks to provide a video coding method and an apparatus that adaptively utilize a single-tree structure and a dual-tree structure in a single block depending on the depth of the entire tree.

At least one aspect of the present disclosure provides a method of decoding a current block by a video decoding device. The method includes decoding, from a bitstream, information of the current block on a luma component, the information of the current block including a size of the current block, a current tree depth, and partitioning information of the current block. The method also includes decoding, from the bitstream, tree structure information of the current block, the tree structure information comprising a single-tree depth indicating a depth to utilize a single tree in an entire tree, a minimum single-tree block size indicating which block size utilizes the single tree in the entire tree, or a dual-tree enable flag indicating whether or not to utilize a dual tree. The method also includes determining a tree structure of the current block based on the size of the current block, the current tree depth, and the tree structure information, wherein the tree structure is indicative of the single tree or the dual tree.

Another aspect of the present disclosure provides a method of encoding a current block by a video encoding device. The method includes obtaining information of the current block on a luma component, the information of the current block including a size of the current block, a current tree depth, and partitioning information of the current block. The method also includes determining tree structure information of the current block, the tree structure information comprising a single-tree depth indicating a depth to utilize a single tree in an entire tree, a minimum single-tree block size indicating which block size utilizes the single tree in the entire tree, or a dual-tree enable flag indicating whether or not to use a dual tree. The method also includes determining a tree structure of the current block based on the size of the current block, the current tree depth, and the tree structure information, wherein the tree structure is indicative of the single tree or the dual tree.

Yet another aspect of the present disclosure provides a computer-readable recording medium storing a bitstream generated by a video encoding method. The video encoding method includes obtaining information of a current block on a luma component, the information of the current block including a size of the current block, a current tree depth, and partitioning information of the current block. The video encoding method also includes determining tree structure information of the current block, the tree structure information comprising a single-tree depth indicating a depth to utilize a single tree in an entire tree, a minimum single-tree block size indicating which block size utilizes the single tree in the entire tree, or a dual-tree enable flag indicating whether or not to use a dual tree. The video encoding method also includes determining a tree structure of the current block based on the size of the current block, the current tree depth, and the tree structure information, wherein the tree structure is indicative of the single tree or the dual tree.

As described above, the present disclosure provides a video coding method and an apparatus that adaptively utilize a single-tree structure and a dual-tree structure in a block depending on the depth of the entire tree. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIGS. 6A through 6C are diagrams illustrating tree structures.

FIG. 7 is a diagram illustrating a method of signaling a tree structure.

FIG. 8 is a diagram illustrating a single-tree structure.

FIG. 9 is a diagram illustrating a common single-dual tree structure, according to at least one embodiment of the present disclosure.

FIG. 10 is a flowchart of a method of determining a tree structure by a video encoding device, according to at least one embodiment of the present disclosure.

FIG. 11 is a flowchart of a method of determining a tree structure by a video decoding device, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

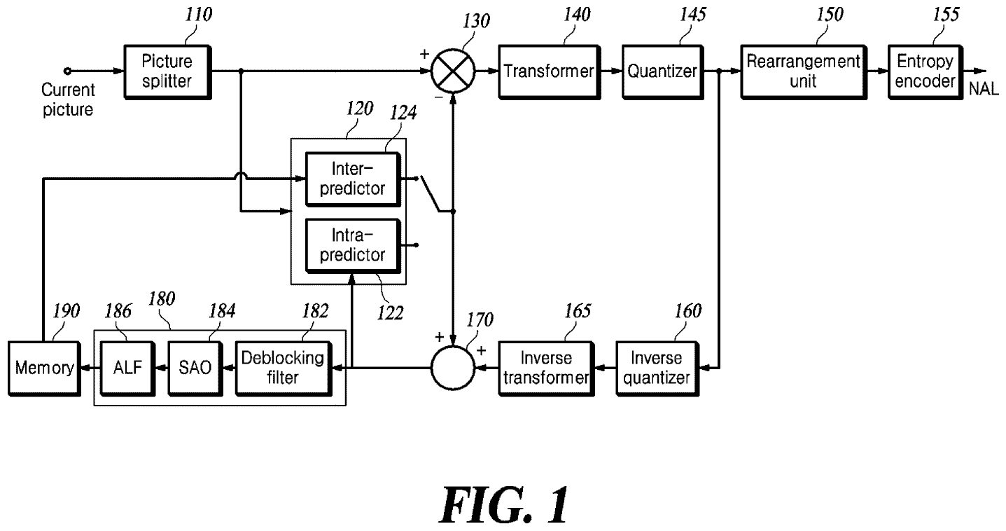

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUS included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

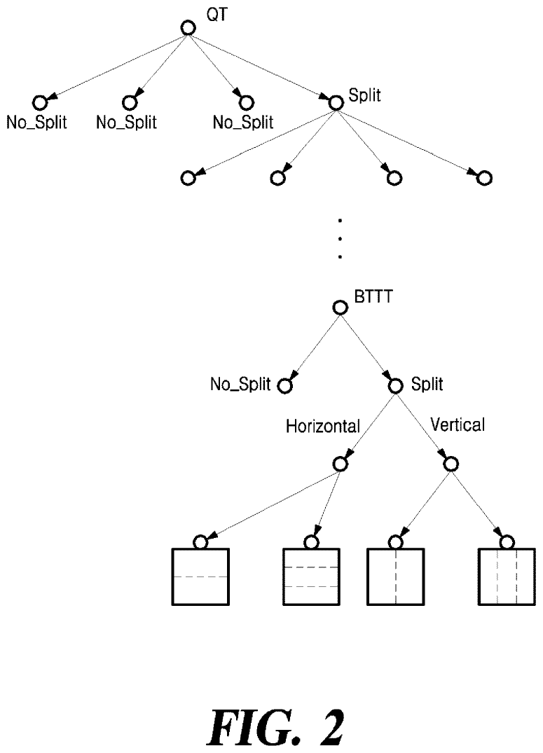

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

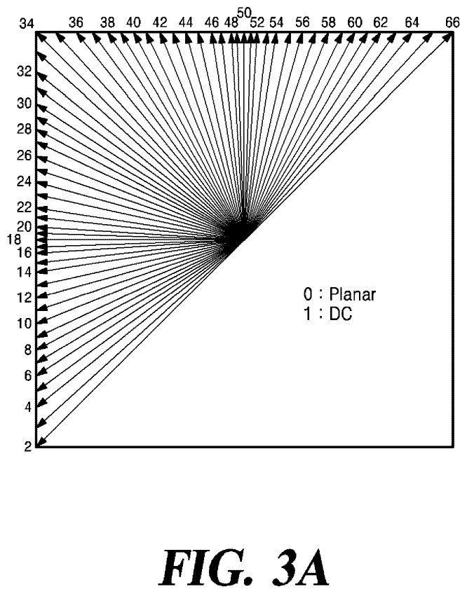

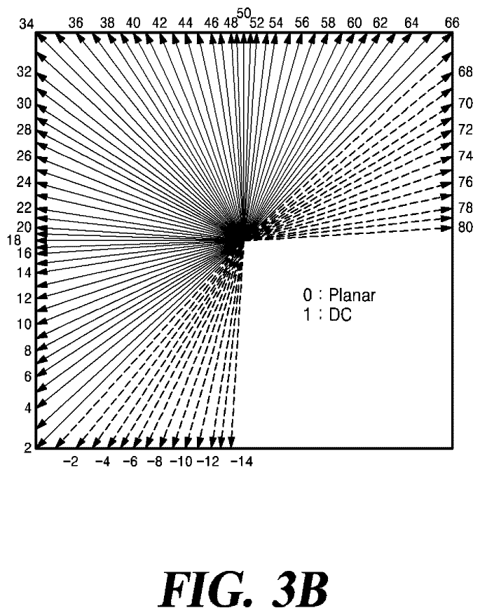

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes ( #67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

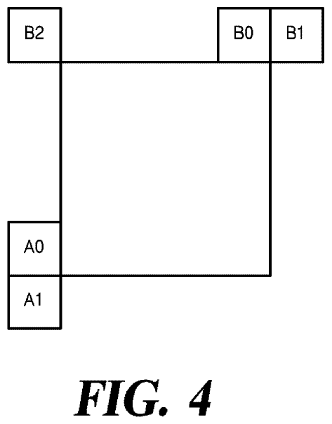

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

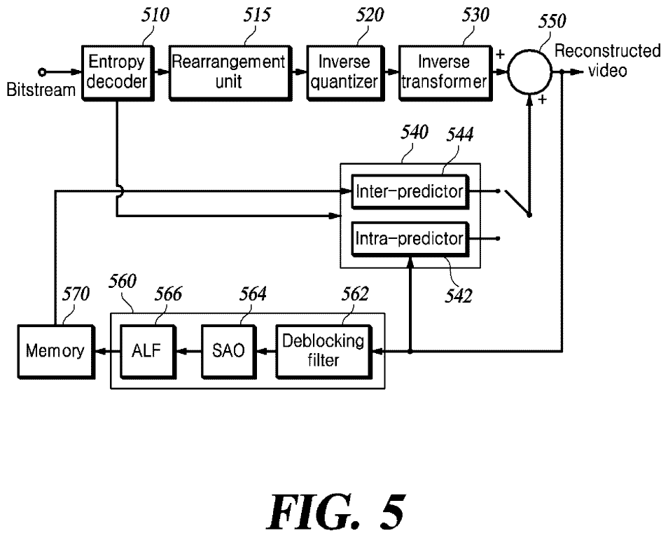

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that adaptively use a single-tree structure and a dual-tree structure in a single block depending on the depth of the entire tree.

The following embodiments may be performed by the picture splitter 110 and the inverse transformer 165 in the video encoding device. The following embodiments may also be performed by the entropy decoder 510 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

The following embodiments are described with respect to the video encoding device, but may be implemented in the same or similar manner in the video decoding device.

### I. Tree Structure for Picture Partitioning

The picture partitioning process of the VVC generates multiple coding units (CUs) based on recursive partitioning of coding tree units (CTUs). The video encoding device first partitions the picture into uniformly sized CTUs. The CTU becomes the uppermost node in the tree structure for partitioning into CUs. Therefore, the maximum size of a CU is equal to the size of a CTU. The picture is first divided into uniformly sized CTUs, and then the respective CTUs may be successively partitioned into CUs. In VVC technique, the maximum size of a CTU is 128×128. Within a CTU, CUs may be formed into various sizes and shapes, ranging from a minimum of 4×4 to the maximum allowable size.

In HEVC, CUs with a maximum size of 64×64 are allowed, whereas VVC allows CUs with a maximum size of 128×128. Thus, compared to HEVC, VVC may utilize CUs with a wider range of allowed sizes, e.g., with a size of 128×128. Additionally, compared to HEVC, VVC may use CUs with diverse partitioning shapes.

As CU partition structures in VVC, binary tree (BT), ternary tree (TT), and quad tree (QT) are utilized, as described above. BT and TT structures are collectively referred to as a

multi-type tree (MTT) structure.

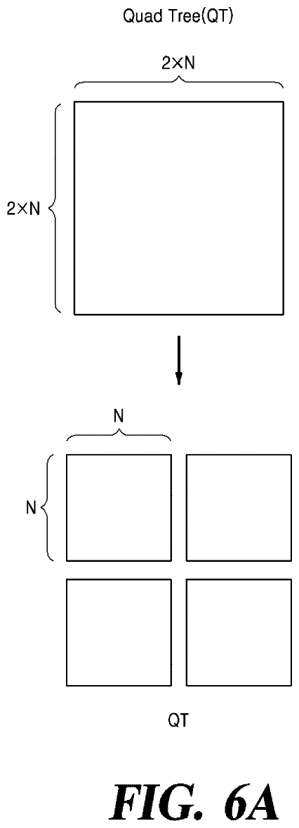

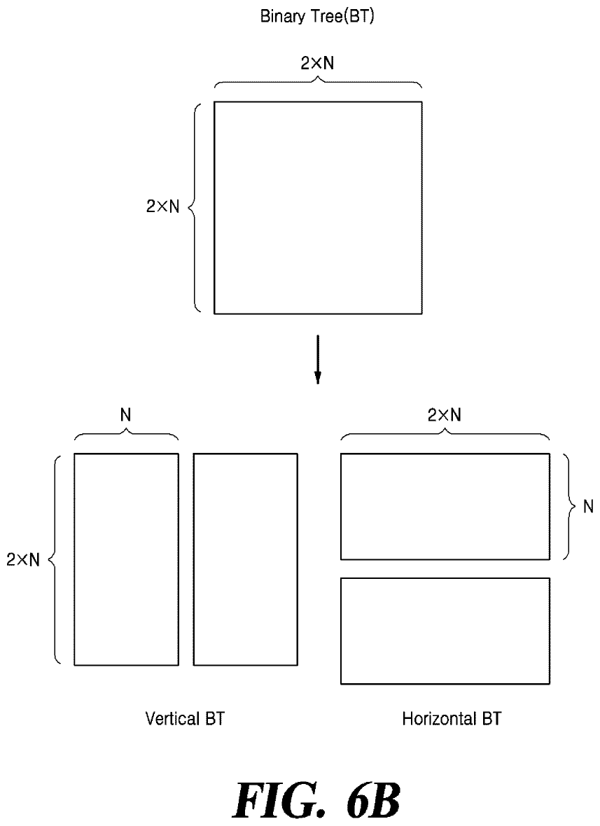

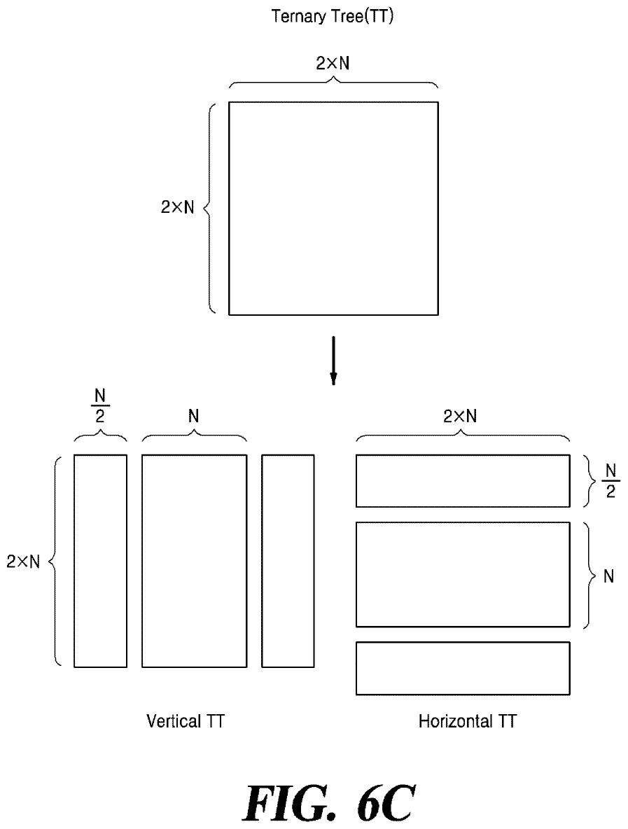

QT is a tree structure with four lower-level nodes under one node, as in HEVC. When applying the QT structure to the current block, as illustrated in FIG. 6A, the current block is partitioned into four equal-sized blocks, each partitioned block corresponding to a lower-level node. BT is a tree that generates two lower-level nodes from a single node, where an upper-level block may be partitioned horizontally or vertically into two lower level blocks of the same size, as illustrated in FIG. 6B. TT generates three lower-level nodes from a single node partitioned in either the horizontal or vertical direction. As illustrated in FIG. 6C, depending on the partitioning direction, the lower level blocks may be generated by partitioning the upper level block horizontally or vertically in a 1:2:1 dimensional ratio.

CUs may have a variety of sizes and shapes, from as small as 4×4 to as large as 128×128. QTs are recursively partitioned within an acceptable size, and are available to BT or TT partitioning once conditions (block size, depth, or the like) are satisfied for MTT configuration. At this point, QT partitioning is no longer available for lower-level nodes that are BT or TT partitioned.

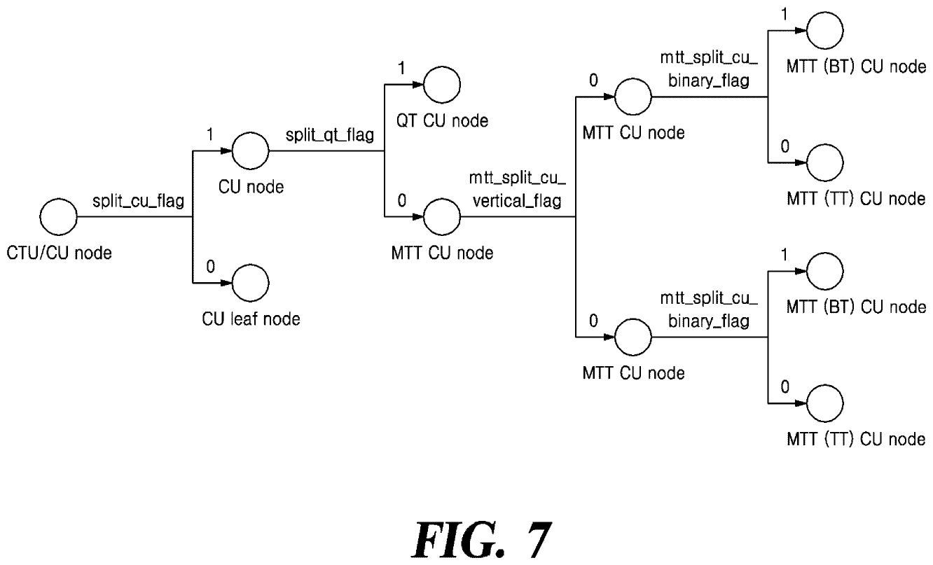

FIG. 7 is a diagram illustrating a method of signaling a tree structure.

In the example of FIG. 7, the root node represents a CTU. The root node is first recursively partitioned by QT. Then, as successive partitioning reaches the minimum size of a block that can no longer be separated by QT, the block is partitioned into smaller blocks by using BT and TT. For example, if the block becomes smaller than the size of MinQTSize, which is signaled to the SPS (Sequence Parameter Set), QT is no longer utilized.

Blocks partitioned by BT and TT are no longer partitioned by using QT. When the depth of the MTT reaches MaxMttDepth, the block is no longer partitioned. When the horizontal or vertical length of the block becomes equal to MinCbsize, the block is no longer partitioned.

In the example of FIG. 7, the split_cu_flag indicates whether to further partition the relevant node, i.e., the relevant block. The split_qt_flag indicates whether to utilize QT or MTT to partition the relevant block. The mtt_split_cu_vertical_flag indicates whether the partitioning direction is horizontal or vertical for MTT partitioning of the relevant block. The mtt_split_cu_binary_flag indicates whether the MTT partitioning of the relevant block is BT or TT.

The picture is a YUV image, which includes a luma component Y, and two chroma components U and V. In VVC, different tree structures may be utilized to partition the picture differently when the characteristics of the luma component and the characteristics of the chroma signal are different.

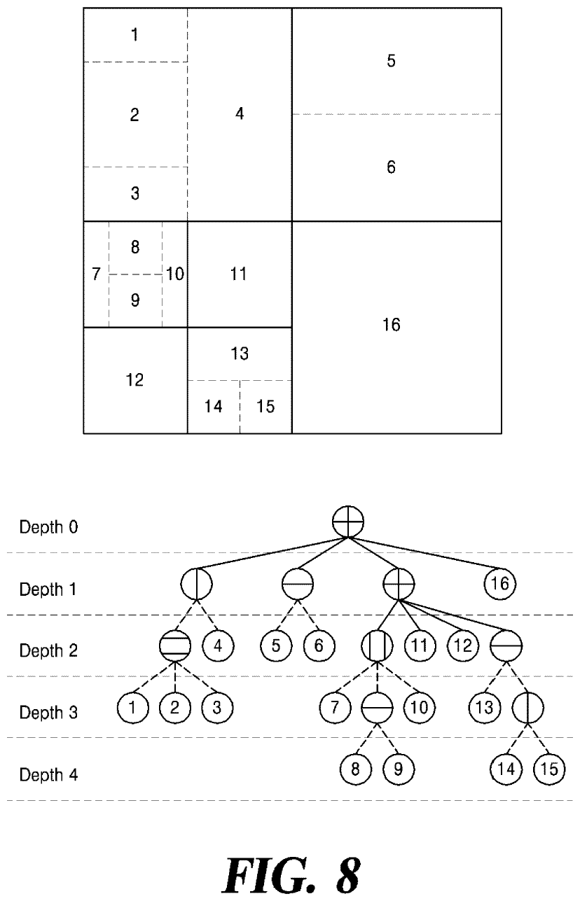

The single-tree structure utilizes the same block partition structure for the luma component and the chroma component. The single-tree structure is used for I, P, or B slices. The single-tree structure may be implemented as shown in the example of FIG. 8. Hereinafter, a single-tree structure is used interchangeably with a single tree. In the example of FIG. 8, the depth of the root node is set to 0.

The dual-tree structure utilizes separate block partition structures for the luma component and the chroma component. The dual-tree structure is available for the I slice. The video encoding device may specify whether a dual tree or single tree is used by signaling a flag to the video decoding device indicating whether the dual tree is used. When the dual-tree structure is used, the smallest luma block has a size of 4×4 and the smallest chroma block has a size of 4×4 or 8×2.

Hereinafter, the dual-tree structure is used interchangeably with the dual tree.

As described above, the type of slice in the video is used as a basis for determining whether to use a single-tree structure or a dual-tree structure for block partitioning. However, with high-quality videos increasing nowadays, the need for the dual tree for the chroma component is increasing regardless of the type of slice. In the following, adaptive use of a single tree and a dual tree depending on the depth of the entire tree is described. For example, a single tree is used from the root node to a certain depth, and from lower-level nodes thereunder, a dual tree is used. According to embodiments, the present disclosure can adaptively use a single tree and a dual tree for different regions in a single image. Accordingly, the present disclosure in some embodiments can improve the quality of the chroma component of the reconstructed image, thereby enhancing the subjective video quality as well as increasing the objective coding efficiency.

### II. Embodiments According to the Present Disclosure

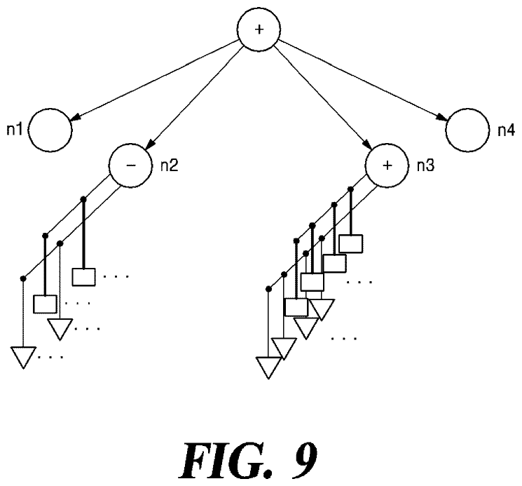

FIG. 9 is a diagram illustrating a common single-dual tree structure, according to at least one embodiment of the present disclosure.

In the example of FIG. 9, the circular nodes represent the nodes of a single-tree structure shared by the luma component and chroma component. The uppermost node is the root node, which represents the CTU. The current CTU (coding tree unit) is partitioned by QT. Four lower-level nodes n1, n2, n3, and n4 are partitioned or not partitioned by non-split, BT, QT, and non-split, respectively. This partition structure is common to the luma component and the chroma component.

In the example of FIG. 9, a dual-tree structure may be utilized from the n2 and n3 nodes downward. For example, block partitioning may be performed separately for the luma component and the chroma component. For example, the triangle node and square node in FIG. 9 represent the block partitioning process of the luma component and the block partitioning process of the chroma component, respectively. Since n2 is being block partitioned with BT, there are two lower-level nodes for each of the luma component and chroma component. n3 is being block partitioned by QT, so there are four lower-level nodes for the luma component and four lower-level nodes for the chroma component. When additional recursive block partitioning from n2 or n3 are performed, the block partition structure of the luma component may become different from that of the chroma component.

In the example of FIG. 9, a single tree is utilized in common for up to depth 1 of the entire tree, and a dual tree is utilized for the remaining depths. The depth at which the single tree is utilized (or the depth at which the dual tree is started) may be adaptively varied within a range of 0 to MaxMttDepth. Here, MaxMttDepth represents the total tree depth. A single_tree_depth (referred to as a ‘single-tree depth’ hereinafter) may be set to indicate the depth at which a single tree is applied. The value of single_tree_depth may be any value in the range of 1 to MaxMttDepth. Based on the value of single_tree_depth, for depths from 0 to single_tree_depth-1, the luma component and the chroma component may share a partition structure, and for depths thereafter, the luma component and the chroma component may have different partition structures.

The partition structure may be adaptively controlled according to one or a combination of the following methods.

The depth value, which is represented by single_tree_depth, of a depth to utilize a single tree in the entire tree is signaled in the unit of SPS, PPS, or subpicture. As described above, based on the value represented by single_tree_depth, a single tree may be utilized for depths from 0 to single_tree_depth-1, and a dual tree may be utilized for depths thereafter.

For nodes that constitute the common single-dual tree, a flag is used indicating whether to use a single tree or a dual tree (hereinafter referred to as a ‘dual-tree enable flag’). For example, if the dual-tree enable flag is 0, a single tree is used in which the luma component and chroma component share the partition structure represented by the current node. If the dual-tree enable flag is 1, a dual tree is used. If a dual-tree structure is used for a node, the single-tree structure is no longer used for its lower-level nodes. On the other hand, if the dual-tree enable flag is not transmitted, the dual-tree enable flag may be assumed to be set to 1. In such a case, the transmission of the dual-tree enable flag may be omitted for lower-level nodes that the node where the dual-tree structure is used.

The block size, which is represented by min_single_tree_block_size, of which block size utilizes the single tree in the entire tree is signaled in the unit of SPS, PPS, or subpicture. Here, min_single_tree_block_size may be the size of a luma block. The use of a single tree is allowed for blocks up to the size represented by min_single_tree_block_size. For blocks smaller than that, a dual tree is used, and the single-tree structure is not used.

In the entire tree, up to the nodes in the range partitioned by QT, a single tree is used. For nodes below that range, a dual tree may be used.

Conditions for the use of a single tree or dual tree may be signaled by using constraints on the use of MTT. For example, if the size of a block does not meet the MinQTSize constraint, i.e., if the block's size does not satisfy the MinQTSize condition, then a single tree is not used for blocks smaller than the block's size. Here, MinQTSize denotes the minimum block size for which QT partitioning is applied. In this case, MinQTSize may be applied relative to the luma block.

When the slice type is I, and when the slice type is B/P, the values of the aforementioned syntax elements, e.g., single_tree_depth, min_single_tree_block_size, and the like may be set differently.

For example, if a single tree is utilized up to a total tree depth of depth 0, for all CUs within the relevant CTU, the present disclosure may allow the use of a dual tree where luma and chroma have different structures. On the other hand, if a single tree is utilized up to a total tree depth of MaxMttDepth, for all CUs within the relevant CTU, the present disclosure allows the use of a single tree where luma and chroma have the same structure.

In one example, the single_tree_depth value may be signaled on a block-by-block basis. In this case, the signaling of single_tree_depth may be made with the value set to 1 or MaxMttDepth. In such a case, for each region in the image, the CTU may select between the dual tree and the single tree, and use the selected tree structure.

Meanwhile, on the video encoding device side, whether or not to apply the dual tree may be determined for the chroma component by using the encoding information of the luma component. For the chroma block determined to be subjected to the dual tree, the video encoding device determines the partitioning information of the chroma component. On the video decoding device side, whether or not to apply the dual tree may be determined for the chroma component by using the decoding information of the luma component. For the chroma block determined to be subjected to the dual tree, the video decoding device decodes the partitioning information of the chroma component.

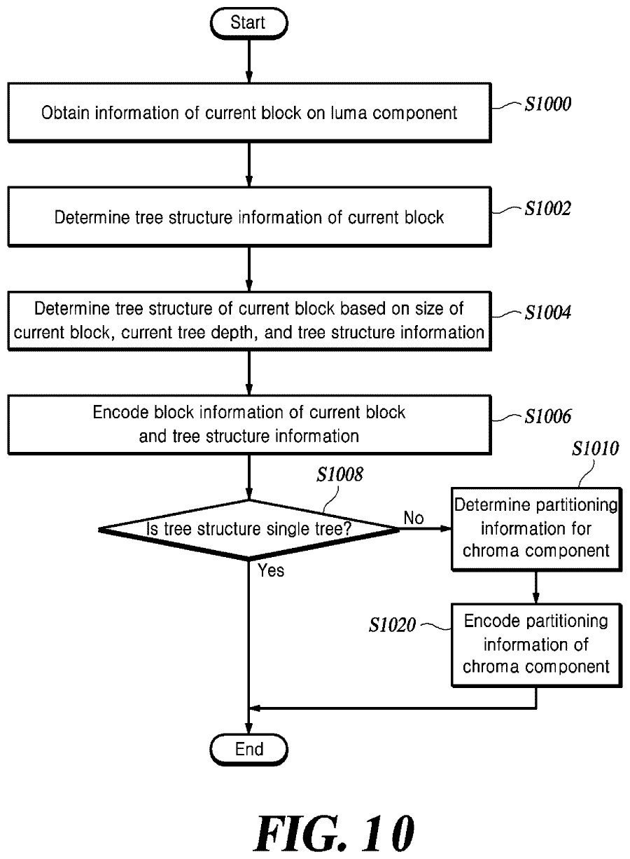

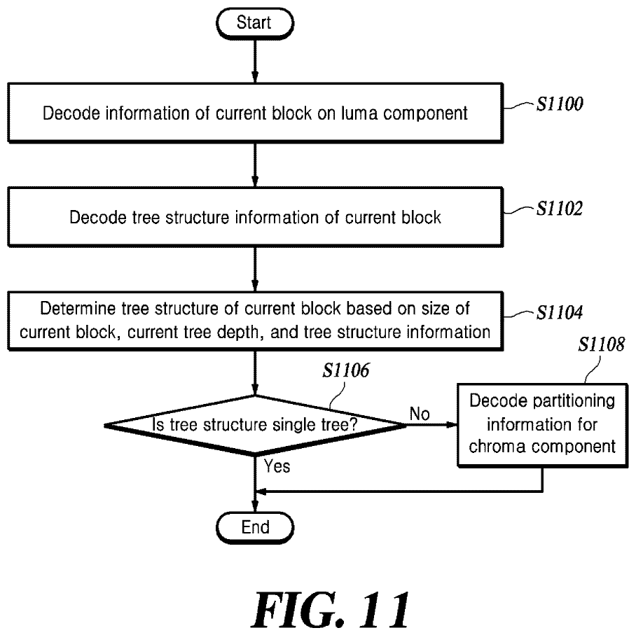

Referring now to FIGS. 10 and 11, methods of determining a tree structure of a current block are described.

FIG. 10 is a flowchart of a method of determining a tree structure by the video encoding device, according to at least one embodiment of the present disclosure.

The video encoding device obtains information of the current block on the luma component (S1000). Here, the information of the current block includes the size of the current block, the current tree depth, and the partitioning information of the current block. From the encoding information of the current block on the luma component, the video encoding device may obtain the size of the current block, the current tree depth, and the partitioning information of the current block.

The video encoding device determines the tree structure information of the current block (S1002). Here, the tree structure information may be a single-tree depth, a minimum single-tree block size, or a dual-tree enable flag. The single-tree depth indicates the depth to utilize a single tree in the entire tree. The minimum single-tree block size indicates which block size utilizes the single tree in the entire tree. The dual-tree enable flag indicates whether or not the dual tree is to be used. In terms of rate-distortion optimization, the video encoding device may determine the single-tree depth, the minimum single-tree block size, or the dual-tree enable flag.

The video encoding device determines the tree structure of the current block based on the size of the current block, the current tree depth, and the tree structure information (S1004). Here, the tree structure indicates a single tree or a dual tree.

The video encoding device encodes the current block information and the tree structure information (S1006).

The video encoding device may signal the single_tree_depth in the unit of SPS, PPS, subpicture, or CTU. In addition, the video encoding device may signal min_single_tree_block_size in the unit of SPS, PPS, or subpicture.

The video encoding device checks the tree structure of the current block (S1008).

If the tree structure of the current block is a dual tree (No in S1008), the video encoding device may perform the following steps (S1010 and S1012).

The video encoding device determines partitioning information for the chroma component of the current block (S1010). In terms of rate-distortion optimization, the video encoding device may determine the partitioning information of the chroma component.

The video encoding device encodes the partitioning information of the chroma component (S1012).

On the other hand, if the tree structure of the current block is a single tree (Yes in S1008), the video encoding device may use the same partitioning information for the chroma component as for the luma component.

FIG. 11 is a flowchart of a method of determining a tree structure by the video decoding device, according to at least one embodiment of the present disclosure.

The video decoding device decodes information of the current block on the luma component from the bitstream (S1100). Here, the information of the current block includes the size of the current block, the current tree depth, and the partitioning information of the current block. From the decoding information of the current block on the luma component, the video decoding device may obtain the size of the current block, the current tree depth, and the partitioning information of the current block.

The video decoding device decodes the tree structure information of the current block from the bitstream (S1102). Here, the tree structure information may be a single-tree depth, a minimum single-tree block size, or a dual-tree enable flag. The single-tree depth indicates the depth to utilize the single tree in the entire tree. The minimum single-tree block size indicates which block size utilizes the single tree in the entire tree. The dual-tree enable flag indicates whether or not a dual tree is to be used.

The video decoding device determines a tree structure for the current block based on the size of the current block, the current tree depth, and the tree structure information (S1104). Here, the tree structure indicates a single tree or a dual tree.

If the current tree depth is included in single_tree_depth, the video decoding device determines the tree structure of the current block to be a single tree. On the other hand, if the current tree depth is not included in single_tree_depth, the video decoding device may determine that the tree structure of the current block is a dual tree. In this case, single_tree_depth is set in a range from depth 0 to the maximum depth of the entire tree (i.e., MaxMttDepth) inclusive.

For nodes that constitute a common single-dual tree, a dual-tree enable flag is used to indicate whether to use a single tree or a dual tree. The video decoding device decodes the dual-tree enable flag. The video decoding device may determine the tree structure of the current block based on the value of the determined flag. If the tree structure of the current block is determined to be a dual tree, the video decoding device determines the tree structure of the lower level blocks that the current block to be a dual tree. On the other hand, if the dual-tree enable flag is not transmitted, the dual-tree enable flag may be assumed to be set to 1. In such a case, the video decoding device may omit decoding the dual-tree enable flag for the lower-level nodes than the node where the dual-tree structure is used.

If the size of the current block is greater than or equal to min_single_tree_block_size, the video decoding device determines the tree structure of the current block to be a single tree. On the other hand, if the size of the current block is less than min_single_tree_block_size, the video decoding device determines the tree structure of the current block to be a dual tree.

When the current block is a node that falls in a range of partitioning by the quad tree (QT) in the entire tree, the video decoding device determines the tree structure of the current block to be the single tree.

If the size of the current block does not satisfy the condition of the minimum QT size (MinQTSize), the video decoding device determines that the tree structure of the current block is a dual tree. Here, the minimum QT size indicates the minimum size of the block to apply QT partitioning.

The video decoding device checks the tree structure of the current block (S1106).

If the tree structure of the current block is a dual tree (No in S1106), the video decoding device decodes the partitioning information for the chroma component of the current block (S1108).

On the other hand, if the tree structure of the current block is a single tree (Yes in S1106), the video decoding device may use the same partitioning information for the chroma component as for the luma component.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “. . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

110: picture splitter
155: entropy encoder
510: entropy decoder

1. A method of decoding a current block by a video decoding device, the method comprising:
decoding, from a bitstream, information of the current block on a luma component, the information of the current block including a size of the current block, a current tree depth, and partitioning information of the current block;
decoding, from the bitstream, tree structure information of the current block, the tree structure information comprising a single-tree depth indicating a depth to utilize a single tree in an entire tree, a minimum single-tree block size indicating which block size utilizes the single tree in the entire tree, or a dual-tree enable flag indicating whether or not to utilize a dual tree; and
determining a tree structure of the current block based on the size of the current block, the current tree depth, and the tree structure information,
wherein the tree structure is indicative of the single tree or the dual tree.

2. The method of claim 1, wherein determining the tree structure comprises:
determining the tree structure of the current block to be the single tree when the current tree depth is included in the single-tree depth, and determining the tree structure of the current block to be the dual tree when the current tree depth is not included in the single-tree depth.

3. The method of claim 2, wherein the single-tree depth is set within a range comprising 0 to a maximum depth of the entire tree.

4. The method of claim 1, wherein determining the tree structure comprises:
determining a tree structure of the current block based on a value of the dual-tree enable flag, and holding from decoding of the dual-tree enable flag for lower level blocks of the current block.

5. The method of claim 1, wherein determining the tree structure comprises:
responsive to when determining the tree structure of the current block to be the dual tree, determining a tree structure of lower level blocks of the current block to be the dual tree.

6. The method of claim 1, wherein determining the tree structure comprises:
determining the tree structure of the current block to be the single tree when the size of the current block is equal to or greater than the minimum single-tree block size, and determining the tree structure of the current block to be the dual tree when the size of the current block is smaller than the minimum single-tree block size.

7. The method of claim 1, wherein determining the tree structure comprises:
responsive to when the current block is a node that falls in a range of partitioning by a quad tree (QT) in the entire tree, determining the tree structure of the current block to be the single tree.

8. The method of claim 1, wherein determining the tree structure comprises:
determining the tree structure of the current block to be the dual tree when the size of the current block does not satisfy a condition of a minimum quad tree (QT) size that represents a minimum block size among block sizes subject to QT partitioning.

9. The method of claim 1, wherein the single-tree depth and the minimum single-tree block size are set differently based on a type of a slice containing the current block.

10. The method of claim 1, wherein determining the tree structure comprises:
determining the tree structure of the current block to be the dual tree when the single tree is utilized up to depth 0 of the entire tree, and determining the tree structure of the current block to be the single tree when the single tree is utilized up to a maximum depth of the entire tree.

11. The method of claim 10, wherein determining the tree structure comprises:
applying either the single tree or the dual tree per coding tree unit (CTU) containing the current block.

12. The method of claim 1, further comprising, when determining the tree structure of the current block to be the dual tree:
decoding partitioning information of a chroma component of the current block.

13. A method of encoding a current block by a video encoding device, the method comprising:
obtaining information of the current block on a luma component, the information of the current block including a size of the current block, a current tree depth, and partitioning information of the current block;
determining tree structure information of the current block, the tree structure information comprising a single-tree depth indicating a depth to utilize a single tree in an entire tree, a minimum single-tree block size indicating which block size utilizes the single tree in the entire tree, or a dual-tree enable flag indicating whether or not to use a dual tree; and
determining a tree structure of the current block based on the size of the current block, the current tree depth, and the tree structure information,
wherein the tree structure is indicative of the single tree or the dual tree.

14. The method of claim 13, further comprising:
encoding the information of the current block and the tree structure information.

15. The method of claim 13, further comprising, when determining the tree structure of the current block to be the dual tree:
determining partitioning information of a chroma component of the current block; and
encoding the partitioning information of the chroma component.

16. A computer-readable recording medium storing a bitstream generated by a video encoding method, the video encoding method comprises:
obtaining information of a current block on a luma component, the information of the current block including a size of the current block, a current tree depth, and partitioning information of the current block;
determining tree structure information of the current block, the tree structure information comprising a single-tree depth indicating a depth to utilize a single tree in an entire tree, a minimum single-tree block size indicating which block size utilizes the single tree in the entire tree, or a dual-tree enable flag indicating whether or not to use a dual tree; and
determining a tree structure of the current block based on the size of the current block, the current tree depth, and the tree structure information,
wherein the tree structure is indicative of the single tree or the dual tree.
